(19) United States
(12) Patent Application Publication
(10) Pub. No.: US 2010/0241478 A1
(43) Pub. Date: Sep. 23, 2010

(54) METHOD OF AUTOMATING SECURITY RISK ASSESSMENT AND MANAGEMENT WITH A COST-OPTIMIZED ALLOCATION PLAN

(76) Inventor: Mehmet Sahinoglu, Montgomery, AL (US)

Correspondence Address: MEHMET SAHINOGLU, 7542 MOSSY OAK DRIVE, MONTGOMERY, AL, 36117, US

(21) Appl. No.: 12/407,892

(22) Filed: Mar. 20, 2009

(51) Int. Cl. G06Q 10/00; G06Q 50/00; G06N 5/02

(52) U.S. Cl. 705/8; 705/7; 706/52

(57) ABSTRACT

A method of automating security risk assessment and management and corrective feedback with a cost-optimized allocation plan is disclosed. The method, operable in a computer system, includes presenting an on-line survey questionnaire and receiving, in response to the on-line survey questionnaire, a user-provided answer. The method further includes extracting data from the computer system and calculating, in response to the user-provided answer and the extracted data, a security risk. The method also includes producing, in response to the security risk, the cost-optimized allocation plan. The data and the user-provided answer are recorded in a data repository. The cost-optimized allocation plan is produced using a game-theoretical approach. The cost-allocation allocation plan includes changes to break even a cost differential of an expected cost of loss (ECL), and further assigns realistic market-oriented mitigation costs to each line of action for the user's computer or system.

### FIELD OF THE INVENTION

This invention relates to security risk assessment. More particularly, the invention relates to a method of automating security risk assessment and management with a cost-optimized allocation plan.

### BACKGROUND OF THE INVENTION

Risk assessment methods may be classified as conventionally qualitative and unconventionally quantitative, and recently hybrid. Such a quantitative approach for software assurance—the confidence in being free from intentional or accidental vulnerabilities—is used to determine and even present security risk and has the advantage of being objective in terms of dollar figures. A well-known management proverb says that “what is measured is managed”. Despite these advantages, decision makers tend to lean toward qualitative risk assessments, due to their ease of use and less rigorous input data requirements. A tree diagram, which is gaining popularity in quantitative risk assessment, is a model wherein a variable is first evaluated and the next action follows accordingly. However, there is a widespread reluctance to apply numerical methods. One primary reason is the difficulty in collecting trustworthy data regarding security breaches.

In qualitative risk analyses, which most conventional risk analysts prefer out of convenience, assets can be classified on a scale of “crucial-critical” or “very significant”, “significant”, or “not significant”. Qualitative criticality can be rated on a scale of “fixed immediately”, “fixed soon”, “fixed sometime”, and “fixed if convenient”. Vulnerabilities and associated threats can be rated on a scale of “highly likely”, “likely”, “unlikely”, or “highly unlikely”. On the subject of countermeasures and risk mitigation, the qualitative approach is from “strong (or high)” to “acceptable (or medium)” and “unacceptable (low)”. Among the security models used, the following are most popular: the Bell-LaPadula model, the Biba model, the Chinese Wall model, the Clark Wilson model, the Harrison-Ruzzo-Ullman model, and Information Flow (entropy-equivocation and lattice-based) models.

During the Applicant's daily commute to work for a decade, he often glanced at two billboards. The first billboard showed the “weather condition” quantitatively, such as 68° F. (it did not say “mild”, “warm” or “cold”). The second billboard, located at a nearby Air Force base gate, showed: “Protection: ALPHA or BRAVO or CHARLIE or DELTA”, from the least severe to the most. (In similar fashion, “green”, “yellow”, “orange”, and “red” are used to depict threat levels in the civilian sector such as airports.) This breakdown used a qualitative indicator of the daily status based on a national security data repository. One did not know how to differentiate today's risk quantitatively from that of yesterday's. If there was an index value, such as 90% security, one could better understand the security level, similar to how people understand temperature measured in degrees. The same concept applies to one's personal computer (PC), or a cyber-network, for which one does not know the risk percentage on a daily basis. Even though one may upgrade their commercial product's security level, in the main no one knows how much their commercial product (e.g., PC) has quantitatively improved or changed.

What is needed is a method of assessing system weaknesses and threats to best uncover a design strategy for employing corrective countermeasure actions through a cost-optimized roadmap.

### SUMMARY OF THE INVENTION

The present invention is directed to a method of automating security risk assessment and management with a cost-optimized allocation plan. In one embodiment, the method, which is operable in a computer system, comprises presenting an on-line survey question; receiving, in response to the on-line survey question; a user-provided answer; extracting data from the computer system; calculating, in response to the user-provided answer and the extracted data, a security risk; and producing, in response to the security risk, the cost-optimized allocation plan. The method of the present invention further comprises recording the data and the user-provided answer in a data repository.

The on-line survey question comprises an inquiry regarding vulnerabilities, threats and countermeasures. The step of extracting data from the computer system comprises analyzing data from the computer system to determine what changes, if any, occurred within a specified period of time. The data include at least one of: anti-virus logs, anti-spy ware logs and system event logs.

The step of producing the cost-optimized allocation plan comprises using a game-theoretical approach. The step of producing the cost-optimized allocation plan further comprises calculating a cost for risk-mitigation countermeasures to a vulnerability-threat branch. The risk-mitigation countermeasures include at least one of: firewall, intrusion detection, and virus protection. The step of calculating the cost for risk-mitigation countermeasures includes assigning a percent improvement of the countermeasures to the vulnerability-threat branch. The cost-optimized allocation plan comprises changes to break even a cost differential of an expected cost of loss (ECL).

In another embodiment of the present invention, a method, operable in a computer system, of automating security risk assessment and management with a cost-optimized allocation plan, is disclosed. The method comprises presenting an on-line survey question; receiving, in response to the on-line survey question, a user-provided answer; extracting data from the computer system; recording data from the computer system; recording the data and the user-provided answer in a data repository; calculating, in response to the user-provided answer and the extracted data, a security risk; and producing, in response to the security risk, the cost-optimized allocation plan using a game-theoretical approach, wherein the cost-optimized allocation plan includes changes to break even a cost differential of an expected cost of loss (ECL). A user can also include diagnostic questions using an XML file to add, delete or modify an already available questionnaire or survey.

### BRIEF DESCRIPTION OF THE DRAWINGS

FIG. 1 shows a simplified block diagram of probabilistic inputs and calculated outputs, in accordance with one embodiment of the present invention.

FIG. 2 shows a tree-diagram chart for calculating a security risk, in accordance with one embodiment of the present invention.

FIG. 3 shows results of game-theorestic optimal countermeasures, using survey data of FIG. 7, in accordance with one embodiment of the present invention.

FIG. 4 shows sample questions in a user interface for building the tree diagram in FIG. 5, in accordance with one embodiment of the present invention.

FIG. 5 shows a tree-diagram chart for calculating a security risk, in accordance with one embodiment of the present invention.

FIG. 6 shows a flow diagram for a method of automating security risk assessment and management with a cost-optimized allocation plan, in accordance with one embodiment of the present invention.

FIG. 7 shows a probability chart, which includes vulnerabilities, threats and countermeasures, for a production server at a university center, in accordance with one embodiment of the present invention.

FIG. 8 shows an example of game-theoretic optimal countermeasures with risk management advice, in accordance with one embodiment of the present invention.

### DETAILED DESCRIPTION OF THE PREFERRED EMBODIMENTS

Innovative quantitative risk measurements are needed to compare objective, not only subjective, risk alternatives and manage the existing risk. The present invention establishes a paradigm of transforming conventionally discrete qualitative risk levels, vaguely useful such as “high, medium, low”, to a framework of computing quantitative indices of security. This furthers a cost and benefit improvement in risk mitigation of hardware and software components, and their complex systems. Along the way, theoretical models and algorithms, and test scenarios are analyzed in transitioning from qualitative attributes to quantitative indices for security.

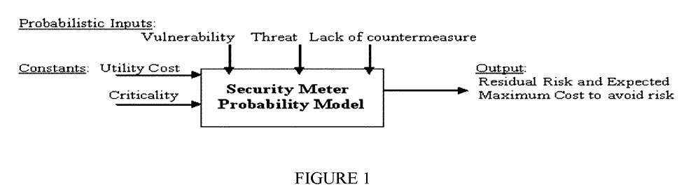

FIG. 1 shows a simplified block diagram of probabilistic inputs and calculated outputs, in accordance with one embodiment of the present invention. In the FIG. 1, the constants in this model are utility cost (dollar asset) and a criticality constant (between 0 and 1), which is another constant that indicates the degree of how critical or disruptive the system is in the event of an entire loss and is taken to be a single value that corresponds to all vulnerabilities with a value ranging from 0.0 to 1.0, or from 0% to 100%. The probabilistic inputs are vulnerability, threat, and lack of countermeasure (LCM), all valued between 0 and 1. Vulnerability is the weakness of a system, such as an email system. A threat is the probability of the exploitation of some vulnerability or weakness within a specified time frame. A countermeasure is a prevention of a threat, such as smoke detectors or generators or antivirus software or firewalls.

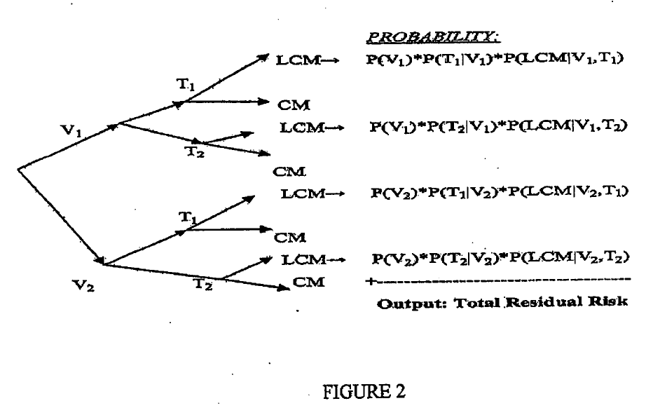

FIG. 1 leads to the probabilistic tree diagram of FIG. 2 for calculating a security risk. Suppose an attack is attempted. Out of 100 such attempts, the number of penetrating attacks will give the estimate of the percentage of LCM. One can then trace the root cause of the threat level retrospectively in the tree diagram of FIG. 2. As an example of a scenario: A virus attack as a threat occurs, and anti-virus software does not detect it. As a result of this attack, whose root threat is known, the e-mail system as a vulnerability may be compromised. This illustrates the “line of attack” on the tree diagram in FIG. 2. Out of 100 such cyber attacks, hardware or software in nature, that maliciously harmed the target operation in some manner, how many of them were not counter-measured by e.g., smoke detectors, or installed antivirus software, or firewall? Out of those that are not prevented by a certain countermeasure (CM) device, how many of them were caused by threat 1 or 2, etc., to a particular vulnerability 1 or 2 etc.? We calculate then, as in FIG. 2: Residual Risk (RR)=Vulnerability×Threat×LCM, for each branch to obtain a total residual risk (TRR).

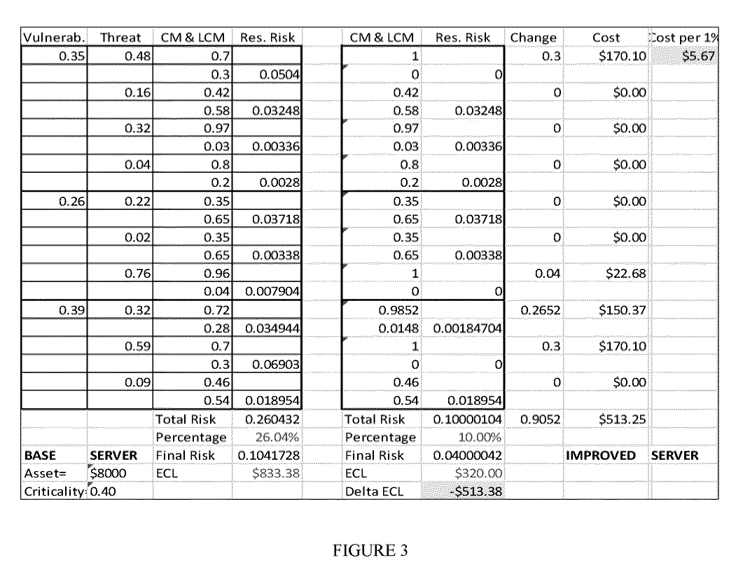

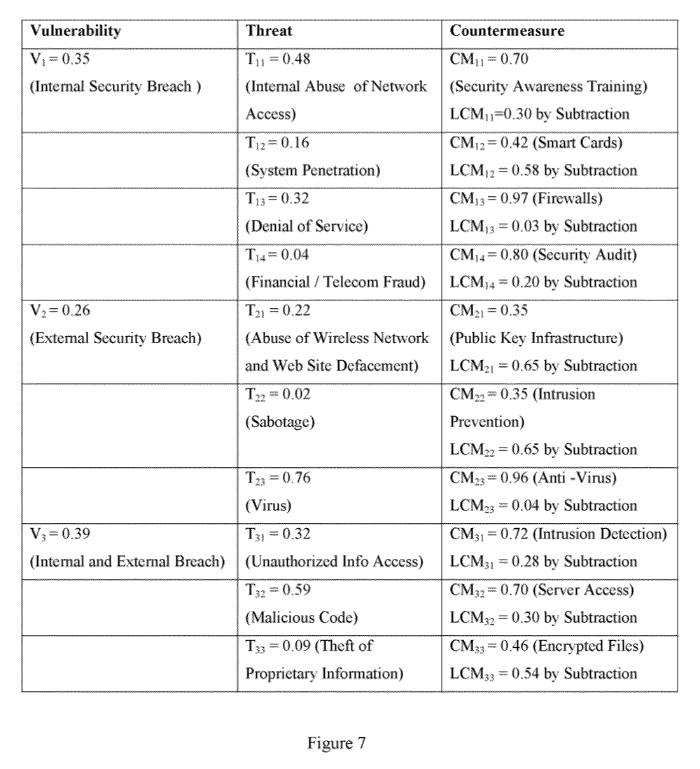

FIG. 3 shows results of game-theorestic optimal countermeasures, using survey data of FIG. 7, in accordance with one embodiment of the present invention. The FIG. 3 shows a breakeven cost of $5.67 (on the upper right corner) accrued per 1% countermeasure improvement. This is the result after the countermeasures are taken to bring the undesirable security risk (e.g. 26.04%) to a more desirable percentage (e.g. 10%). The average breakeven cost C per 1% is calculated to cover personnel, hardware and software. On the positive side, the Expected Cost of Loss (ECL) will decrease with a gain of Δ ECL while the software/hardware CM improvements are added on. The breakeven point is where the benefits and costs are equal, using corrective actions. The Base Server of the example in the FIG. 3 shows the organizational policy of mitigating the RR from 26.04% down to 10% (≦10%) in the Improved Server. Then for each improvement action, such as increasing from 70% to 100% for v₁t₁ branch etc., 30×$5.67=$170.10 is spent. The total minimized change of 90.52%×$5.67 per 1%=$513 improvement cost, and Δ ECL=$833.38 (base server)−$320.22 (improved server)=$513 for a lower resulting RR are now identical. The FIG. 3 shows how risk is managed with a game-theoretical algorithm of threats vs. countermeasures as two opposing rivals. Later, game-theory will be applied to find a cost-optimal mitigation plan. FIG. 7 shows a probability chart, which includes vulnerabilities, threats and countermeasures, for a production server at a university center, used for calculating the results in the FIG. 3. The chart of FIG. 7 was estimated from a related security survey of U.S. University's Computer Center.

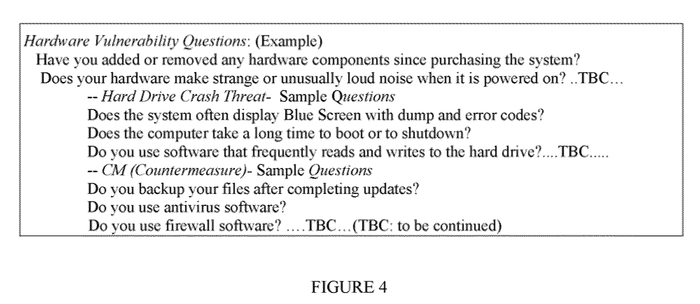

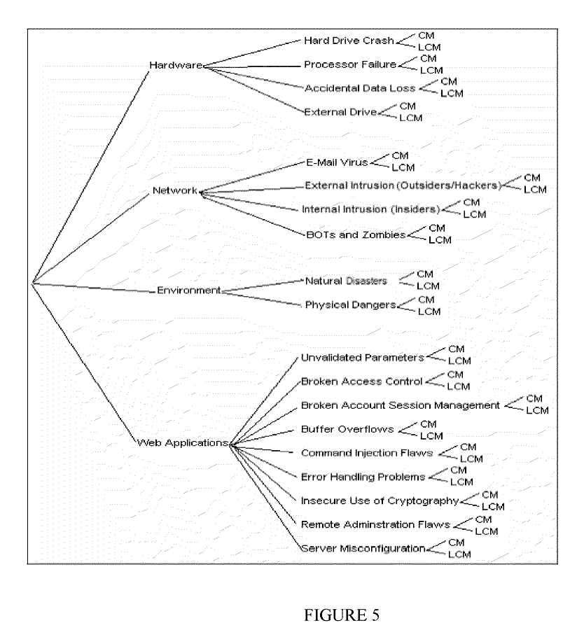

FIG. 4 shows sample questions in a user interface for building the tree diagram in FIG. 5, which shows a tree-diagram chart for calculating a security risk, in accordance with one embodiment of the present invention. FIG. 4 illustrates an initial step of the present invention of surveying and collecting or extracting data from a user's PC regarding vulnerabilities, threats, and countermeasures (or lack thereof). For example, a person boots his computer and faces a number of questions, such as a self-surveying software that asks for input data about his security concerns, namely vulnerabilities, threats and countermeasures. Auxiliary software can be used to determine what changes, if any, occurred to the user's PC within, say, the past 24 hours, for instance: reviewing antivirus logs, anti-spyware logs, and system event logs. These data and findings can be recorded daily in a data repository daily. The daily security risk out of 100% is calculated and given to the user. Then, using a game theoretical approach, an optimal allocation plan is produced to alert the user about certain countermeasures, such as how, for example, a firewall can increase awareness on a vulnerability (e.g., network) to a threat (e.g., hacking). Residual risk is calculated based on the survey data and findings, and the cost for risk-mitigation countermeasures is calculated. These countermeasures can include firewall, intrusion detection, virus protecion, etc.

In the above, a game-theoretical algorithm is utilized through mathematical optimization techniques to derive an optimal schedule to assign the percent improvement of countermeasures to a particular vulnerability-threat branch. Optimal percentage changes are applied to breakeven the cost differential of the Expected Cost of Loss (ECL). Thus, vulnerabilities and threat levels are mitigated by employing countermeasures through a cost-optimized roadmap.

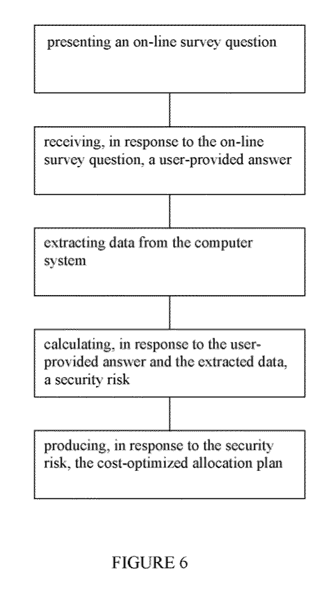

FIG. 6 shows a flow diagram for a method 600 of automating security risk assessment and management with a cost-optimized allocation plan, in accordance with one embodiment of the present invention. In the step 610 of FIG. 6, an on-line survey question is presented. In the step 620, a user-provided answer is received in response to the on-line survey question. In the step 630, data is extracted from a computer system. In the step 640, a security risk is calculated in response to the user-provided answer and the extracted data. In the step 650, a cost-optimized allocation plan is produced in response to the security risk. The method 600 can further comprise recording the data and the user-provided answer in a data repository. The method 600 can also comprise modifying questions in the on-line survey or XML survey. There is an added convenience whereby a user can included diagnostic questions using an XML file to add, delete or modify an already available questionnaire.

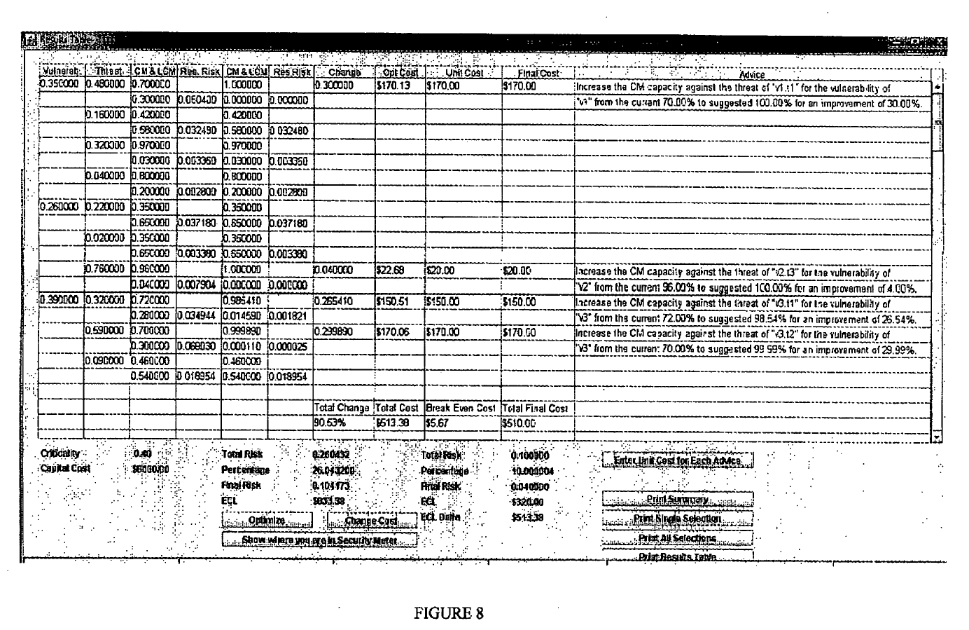

FIG. 8 shows an example of game-theoretic optimal countermeasures with risk management advice, in accordance with one embodiment of the present invention. For example, as shown in the FIG. 8, the risk management advice can take the form of: “Increase the countermeasure capacity against the threat of ‘Accidental Data Loss” for the vulnerability by . . . ” to ‘Increase the countermeasure capacity against the threat of ‘Natural Disasters” for the vulnerability by . . . ”

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modification may be made in the embodiments chosen for illustration without departing from the spirit and scope of the invention

What is claimed is:

1. A method, operable in a computer system, of automating security risk assessment and management with a cost-optimized allocation plan, comprising:
a. presenting an on-line survey question;
b. receiving, in response to the on-line survey question, a user-provided answer;
c. extracting data from the computer system;
d. calculating, in response to the user-provided answer and the extracted data, a security risk; and
d. producing, in response to the security risk, the cost-optimized allocation plan.

2. The method of claim 1 wherein the on-line survey question comprises an inquiry regarding vulnerabilities, threats and countermeasures.

3. The method of claim 1 wherein the extracting comprises analyzing data from the computer system to determine what changes, if any, occurred within a specific period of ti me.

4. The method of claim 3 wherein the data include at least one of: anti-virus logs, anti-spy ware logs and system event logs.

5. The method of claim 4 further comprising recording the data and the user-provided answer in a data repository.

6. The method of claim 1 wherein the producing the cost-optimized allocation plan comprises using a game-theoretical approach.

7. The method of claim 6 wherein the producing the cost-optimized allocation plan comprises calculating a cost for risk-mitigation countermeasures to a vulnerability-threat branch.

8. The method of claim 7 wherein the risk-mitigation countermeasures include at least one of: firewall, intrusion detection, and virus protection.

9. The method of claim 7 wherein the calculating the cost for the risk-mitigation countermeasures includes assigning a percent improvement of the countermeasures to the vulnerability-threat branch.

10. The method of claim 9 wherein the cost-optimized allocation plan comprises changes to break even a cost differential of an expected cost of loss (ECL).

11. The method of claim 1 further comprising modifying questions in the on-line survey using XML files mobile.

12. A method, operable in a computer system, of automating security risk assessment and management with a cost-optimized allocation plan, comprising:
a. presenting an on-line survey question;
b. receiving, in response to the on-line survey question, a user-provided answer;
c. extracting data from the computer system;
d. recording the data and the user-provided answer in a data repository;
e. calculating, in response to the user-provided answer and the extracted data, a security risk; and
f. producing, in response to the security risk, the cost-optimized allocation plan using a game-theoretical approach, wherein cost-optimized allocation plan includes changes to break even a cost differential of an expected cost of loss (ECL).

13. The method of claim 12 wherein the on-line survey question comprises an inquiry regarding vulnerabilities, threats and countermeasures.

14. The method of claim 13 wherein the extracting comprises analyzing data from the computer system to determine what changes occurred within a specific period of time.

15. The method of claim 14 wherein the data include at least one of: anti-virus logs, anti-spy ware logs and system event logs.

16. The method of claim 12 wherein the producing the cost-optimized allocation plan comprises calculating a cost for risk-mitigation countermeasures to a vulnerability-threat branch.

17. The method of claim 16 wherein the risk-mitigation countermeasures include at least one of: firewall, intrusion detection, and virus protection.

18. The method of claim 16 wherein the calculating the cost for the risk-mitigation countermeasures includes assigning a percent improvement of the countermeasures to the vulnerability-threat branch.

19. The method of claim 12 further comprising modifying questions in the on-line survey using XML files mobile.
